(19) United States
(12) Patent Application Publication
(10) Pub. No.: US 2012/0304397 A1
(43) Pub. Date: Dec. 6, 2012

(54) UNDERARM STAIN REMOVER COMPOSITION

(76) Inventors: Neil MacDonald, Aberdeen (GB); Rebecca Dare, Aberdeen (GB)

(21) Appl. No.: 13/261,331

(22) PCT Filed: Dec. 21, 2010
(86) PCT No.: PCT/GB10/52180

§ 371 Date: Jun. 20, 2012

(30) Foreign Application Priority Data
Dec. 22, 2009 (GB) 0922389.2

(51) Int. Cl. C11D 3/60; D06L 1/16

(52) U.S. Cl. 8/137; 510/283; 510/284

(57) ABSTRACT

There is herein described a composition which is used to partially or completely remove underarm stains from clothing, specifically the armpit region of clothing.

### FIELD OF THE INVENTION

The present invention relates to a composition which is used to partially or completely remove underarm stains from clothing, specifically the armpit region of clothing.

### BACKGROUND OF THE INVENTION

It is known to provide compositions to remove staining from clothes and generally these should be powerful enough to remove the stains but not powerful enough to remove dyes from the clothes.

However the removal of stains from the underarm or armpit area of clothing is difficult. These stains may be caused by sweat and also antiperspirants, and deodorants that contain Aluminium Chlorohydrate. A variety of commercially available stain removal products were tested for removing such stains and did not adequately succeed.

It is an object of at least one aspect of the present invention to obviate or mitigate at least one or more of the aforementioned problems.

It is a further object of at least one aspect of the present invention to solve or mitigate the problems associated with the prior art.

It is a further object of at least one aspect of the present invention to provide an improved composition for removing underarm stains from clothing, specifically the armpit region of clothing.

### SUMMARY OF THE INVENTION

According to a first aspect of the present invention there is provided a composition used as a stain remover on an armpit region of clothing materials, the composition comprising a cleaning agent and an acid.

According to a second aspect of the present invention there is provided a method of removing deodorant, antiperspirant or sweat stains from clothing, the method compromising contacting an armpit region of clothing materials comprising the stains with a composition according to the first aspect of the invention.

According to a third aspect of the present invention there is provided a composition when used as, a stain remover of clothing materials, the composition comprising a cleaning agent and an acid.

According to a fourth aspect of the present invention there is provided a method of removing deodorant, antiperspirant or sweat stains from clothing, the method compromising contacting clothing materials comprising the stains with composition according to the third aspect of the invention.

The cleaning agent is typically a soap and/or a detergent, such as a mild detergent surfactant.

Thus, the cleaning agent may be a surfactant, which in turn may be a non-ionic, anionic or cationic surfactant, preferred non-ionic.

The cleaning agent is normally an aqueous based cleaning agent. Thus, the cleaning agent typically comprises a solute and water as the solvent.

The cleaning agent preferably comprises an alcohol ethoxylate, more preferably an alcohol ethoxylate with a carbon chain length of C8-C15 with 5 to 7 moles of ethylene oxide (MEO). The alcohol ethoxylate may be one such as Surfac GM590 (available from SURFAC, UK), which is a preferred example of such an alcohol ethoxylate.

The acid is preferably a dilute strong acid. Preferred embodiments include hydrochloric acid or phosphoric acid. Other suitable acids include one or more of citric acid, and acetic acid. A mixture of hydrochloric acid and phosphoric acid is also used for certain embodiments.

The composition should have a pH<1.

Thus a particularly preferred embodiment comprises an alcohol ethoxylate and hydrochloric acid.

The composition is typically used to remove stains caused by deodorant, antiperspirant, sweat or their mixtures, derivatives or products.

The composition may comprise 1-5 vol %, surfactant such as alcohol ethoxylate.

The composition may comprise 70-99 vol % dilute acid, preferably 85-95 vol %.

The acid may have a molarity of 0.1-5M, 0.5-3M preferably 1-3 M.

For certain embodiments, a gelling or thickening agent is added. This may be an ethoxylated fatty amine.

When a gelling or thickening agent is used, preferably it makes up 1-5 vol % of the composition.

The clothing material treated in the present invention is often shirts and/or T-shirts. The shirts/T-shirts may be made from any material but shirts made from cotton are preferred.

For certain embodiments the clothing material is contacted with the composition and left to soak on the local area of staining. Thereafter, the clothing material is subjected to a subsequent washing step such as a conventional wash in an automatic washing machine or hand-washed. For such embodiments, the contacting step of the present invention may be regarded as a pre-wash treatment.

Preferably all of the components of the composition are completely soluble in water and thus can be removed during such a subsequent wash cycle.

### BRIEF DESCRIPTION OF THE DRAWINGS

Embodiments of the present invention will now be described, by way of example only, with reference to the accompanying drawings in which:

FIG. 1 is a range of photographs showing Comparative Test 1 from an initial condition to a first treatment and then a second treatment;

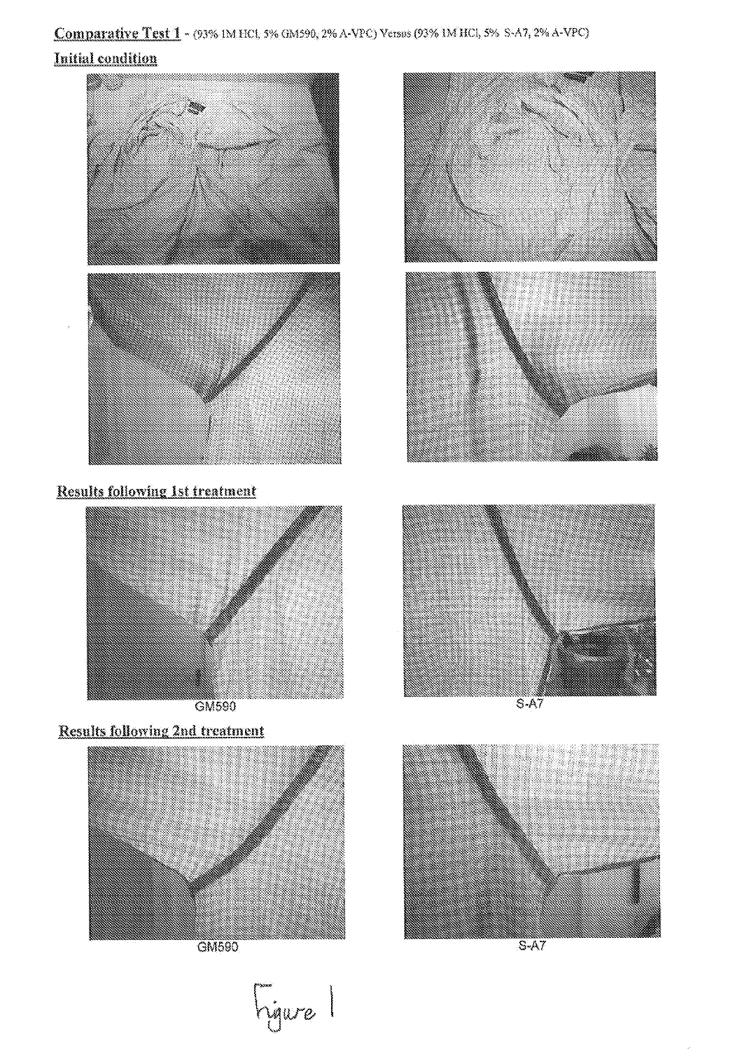

FIG. 2 is a range of photographs showing Comparative Test 2 from an initial condition to a first treatment and then a second treatment;

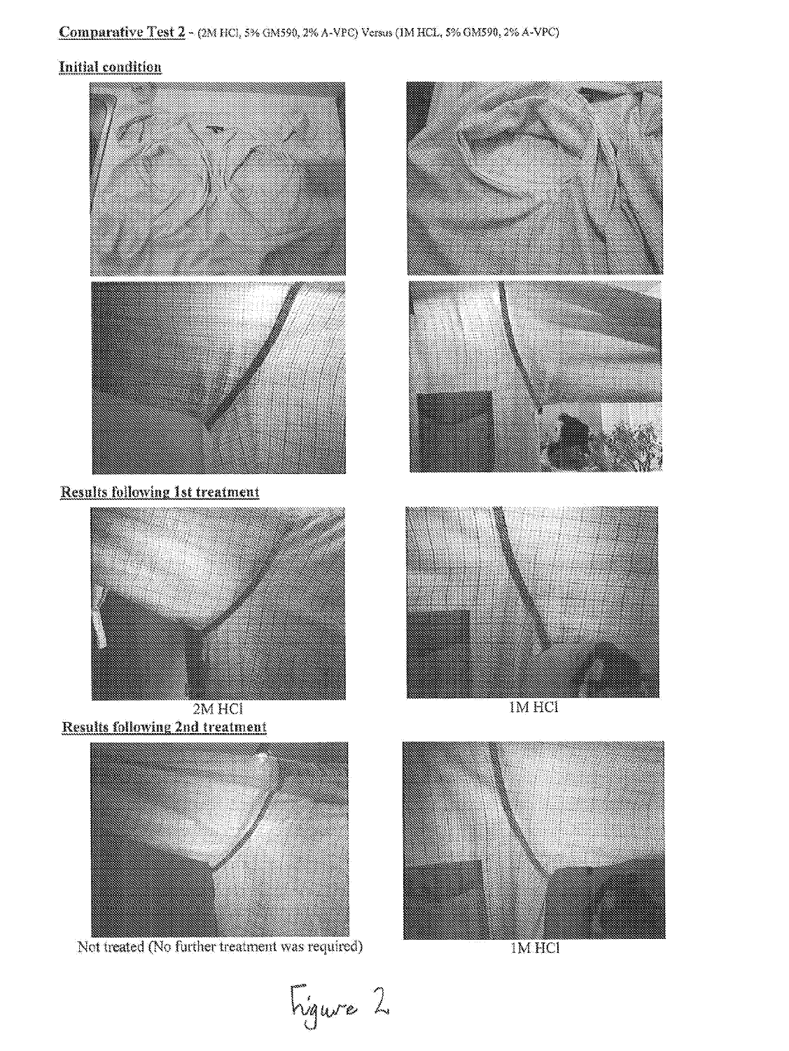

FIG. 3 is a range of photographs showing Comparative Test 3 from an initial condition to a first treatment and then a second treatment; and

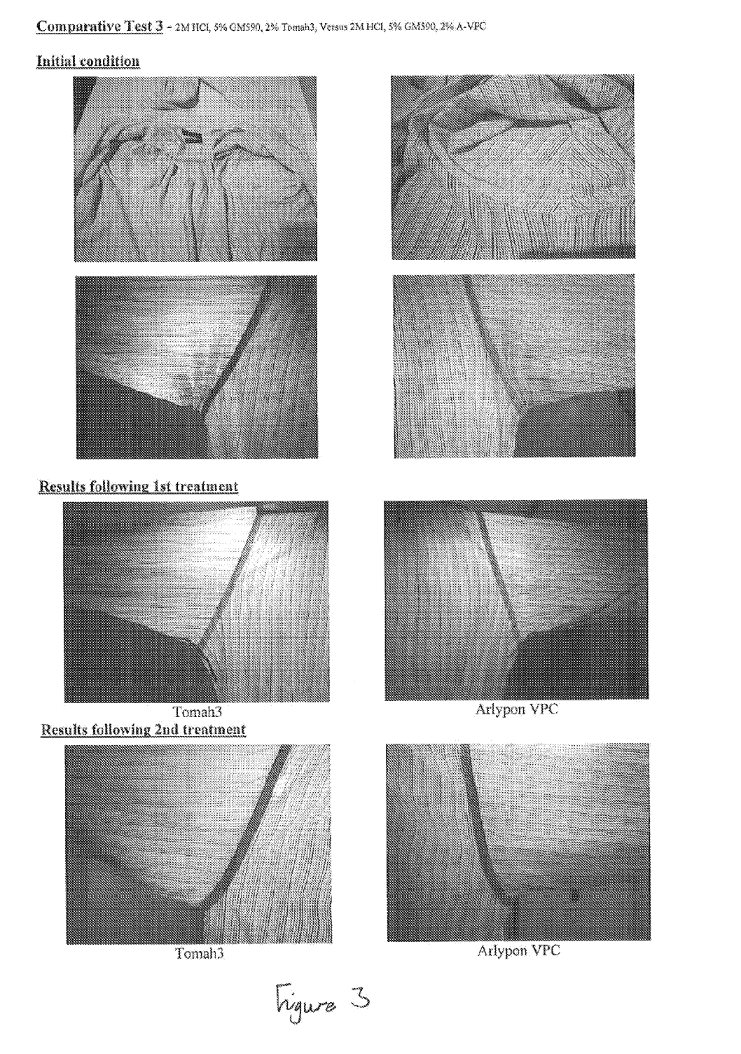

FIG. 4 is a range of photographs showing Comparative Test 4 from an initial condition to a first treatment and then a second treatment

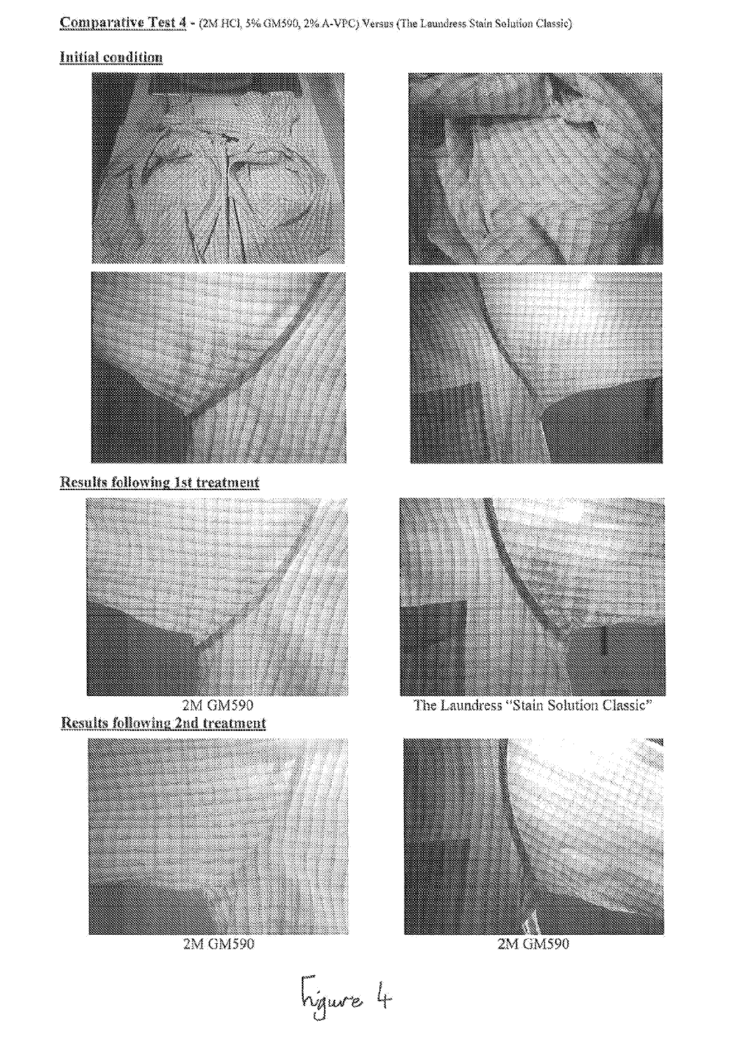

### BRIEF DESCRIPTION

The composition in accordance with the present invention is applied directly to the stained underarm/armpit areas of a garment such as a shirt. The product is then worked into the fabric then left to soak for a period, such 10-30 minutes before then subjecting the garment to a normal automatic washing machine wash cycle. Other soaking periods may be used up to a maximum of 60 minutes, preferably 30 minutes.

### EXAMPLES

### Examples of Preliminary Tests Performed Using Pre-Existing Cleaning Formulations

Tests were performed using a number of existing proprietary stain remover and laundry cleaning products as well as other recommended formulations/compounds. These were tested on garments exhibiting typical underarm stains caused by antiperspirants and deodorants.

For the sake of direct comparison, all testing was undertaken in the same manner, where the products/formulations were applied directly to the stained underarm/armpit areas of a stained garment such as a shirt. The product/formulation was then worked into the fabric then left to soak for a period of approx 30 minutes. The garments were then subjected to a standard wash cycle at 40 deg C. Following the wash cycle, the stained areas were inspected and results recorded. A summary of the products/formulations tested and the results are shown in the table below:

| Product/Formulation Tested | Results |
|---|---|
| Bleach (Domestos ™) (undiluted) | No beneficial effect |
| | (stains became darker) |
| Hydrogen peroxide (undiluted) | No beneficial effect |
| | (stains became darker) |
| Vanish ™ (undiluted) | No effect |
| Shout ™ (undiluted) | No effect |
| White Wizard ™ | No effect |
| Ariel ™ Wash liquid (undiluted) | No effect |
| CIF power ™ (undiluted) | No effect |
| Cillit Bang ™ (undiluted) | No effect |
| Laundress ™ “original stain | No effect |
| remover” (undiluted) | |
| Stain Devil ™ #3 (undiluted) | No effect |
| Glo-white ™ | No effect |
| Vodka | No effect |
| Toothpaste | No effect |
| Baking powder—(sodium | No effect |
| bicarbonate) (mixed with water) | |
| Lemon juice and sodium | No effect |
| bicarbonate | |
| Vinegar and sodium bicarbonate | No effect |
| Various Alcohols: (inc Ethanol, | No effect |
| Methanol, Butanol, Propanol) | |
| Acetone | No effect |
| Solvents: White spirits, | No effect |
| Methylated sprits, Turpentine, | |
| Thinners | |
| Oils & Hydrocarbons: (inc Baby | No effect |
| oil, Olive oil, mineral engine oil, | |
| Petrol, WD40) | |
| Vinegar (distilled white) | Slight effect on lighter stained areas |
| | (approx 5% reduction of stain). No |
| | appreciable effect on hardened |
| | deposits. |
| Lemon Juice | Slight effect on lighter stained areas |
| | (approx 10% reduction of stain). |
| | No appreciable effect on hardened |
| | deposits. |

### COMPARATIVE EXAMPLES

### Comparative Testing of Acid Solutions

As a result of the preliminary testing, it was evident that lemon juice and to a lesser extent vinegar, were the only compounds that exhibited any potential to be able to remove underarm stains caused by antiperspirant. Based on this, comparative testing was undertaken using different acids. In addition to Acetic and Citric acid, phosophoric and hydrochloric acids were also tested. Sulphuric and Nitric acids were discounted on personal safety and fabric compatibility grounds.

For the sake of comparison, the selected acid solutions were applied directly to the stained underarm/armpit areas of garments. The acid was then worked into the fabric then left to soak for a period of approx 30 minutes. The garments were subsequently subjected to a standard wash cycle at 40 deg C. Following the wash cycle, the stained areas were visually inspected and results recorded. A summary of results are shown in the table below:

| Acids Tested | Results |
|---|---|
| Acetic acid (20%) | Slight effect on lighter stained areas (approx 5% |
| | reduction of stain). No appreciable effect on |
| | hardened deposits. |
| Citric acid (20%) | Slight effect on lighter stained areas (approx 10% |
| | reduction of stain). No appreciable effect on |
| | hardened deposits. |
| Phosphoric acid (10%) | Moderate effect on lighter stained areas (approx |
| | 30% reduction of stain). Slight effect on hardened |
| | deposits. |
| Hydrochloric acid | Effective on lighter stained areas (approx 50% |
| (8 vol % concentrated | reduction of stain). Moderate effect on hardened |
| HCl) (1M) | deposits |

During these tests, it was noted that the liquid was prone to bead and sit on the surface of the fabric of the garment and needed to be worked into it to “wet” the fabric. It was also noted that the low viscosity of the pure acid solution, resulted in it being difficult to control and limit the area of the fluid application to the stained areas of the garment.

### Comparative Testing of Surfactant/Detergent Additives to the Acid Solution

From the results of effectiveness tests undertaken with the aforementioned dilute acid solutions, the primary focus was on hydrochloric acid as a base ingredient (with phosphoric acid as a secondary preference). In order to enhance the effectiveness of the solution, a number of readily available, general purpose proprietary detergents were tested as additives to the dilute hydrochloric acid.

For the sake of direct comparison, the solutions were applied directly to the stained underarm/armpit areas of garments. The solution was then worked into the fabric then left to soak for a period of approx 30 minutes. The garments were subsequently subjected to a standard wash cycle at 40 deg C. Following the wash cycle, the stained areas were visually inspected and results recorded. A summary of the tests is shown in the table below:

| Test | Results |
|---|---|
| 10 vol % Ariel ™ biological | An approximate 70% reduction in staining |
| washing machine liquid | was observed. However, it was also noted |
| (widely available in grocery | that the Ariel ™ liquid appeared to |
| stores in the UK at least), | react with the acid, changing from its |
| mixed with 1M HCl. | green colour to a cream colour and didn't |
| | seem to fully dissolve. |
| 10 vol % FairyTM dish | An approximate 60% reduction in staining |
| washing cleaning agent | was observed. On various attempts this |
| (widely available in grocery | was found to be effective at removing the |
| stores in the UK at least), | lighter stains, but the harder crusted stains |
| mixed with 1M HCl. | appeared to be still intact. Similar to the |
| | Ariel liquid, the liquid appeared to react |
| | with the acid. |
| 10 vol % Cif ™ power cream | A similar result to the examples above was |
| bathroom cleaner (widely | obtained. |
| available in grocery stores | |
| in the UK at least), mixed | |
| with 1M HCl. | |

Without being bound by theory, it is thought that the HCI chemically reacted to some degree with these proprietary detergent formulations and this in turn may have reduced the effectiveness of the resulting mixture. Nevertheless, it is shown in these examples, that the addition of surfactants/detergents may be used to enhance the cleaning effectiveness of the acid solution at dissolving the aluminium salt deposits and removing the associated fabric stains.

### Comparative Testing of Acid Tolerant Surfactant & Thickening Additive

In order to enhance the effectiveness, stability and usability of the solution, various acid tolerant surfactant and thickening additives were tested.

For the sake of direct comparison, the solution mixtures were applied directly to the stained underarm/armpit areas of garments. The solution was then worked into the fabric then left to soak for a period of approx 30 minutes. The garments were subsequently subjected to a standard wash cycle at 40 deg C. Following the wash cycle, the stained areas were visually inspected and results recorded. A summary of the tests is shown in the table below:

| Test | Results |
|---|---|
| 10 vol % Alcohol ethoxylate | No appreciable effect on stains was observed. |
| (Synperonic A7 ™ - acid | |
| tolerant surfactant). Diluted | |
| with water only. | |
| 10 vol % Alcohol ethoxylate | The result was highly effective with 90-100% of the |
| (Synperonic A7 ™), mixed | stains being removed. Heavy deposits were |
| with 90% 1M HCl. | significantly removed. In the majority of cases |
| | 100% effective within 2 treatment cycles. The |
| | alcohol ethoxylate fully dissolved in the acid and |
| | the solution remained stable. |
| 5 vol % Arlypon VPC ™ | The addition of the thickening agent did not detract |
| thickening agent (a blend of | from the effectiveness of the base formulation. The |
| ethoxylated fatty alcohols | result was highly effective, as above with 90-100% |
| and ethoxylated fatty | stain removal. The resulting thick “gel” was easier |
| amines) mixed with 10 vol % | to control and apply to the stained area of the |
| Alcohol ethoxylate), and | garments. However, it was noted that in some |
| 85 vol % 1M HCl. | garments there was a tendency for traces of the |
| | mixture to remain on the garment (in the seams) |
| | following the wash cycle. |
| 2 vol % Arlypon VPC ™ | The result was highly effective, as above with 90-100% |
| mixed with 10 vol % Alcohol | stain removal. The resulting thinner “gel” |
| ethoxylate), and 88 vol % 1M | was still easy to control and apply to the stained |
| HCl. | area of the garments but without the adverse |
| | residue issues found with the thicker mixture. Also, |
| | at this viscosity, it is possible to use a finger pump |
| | spray or trigger spray type dispenser to apply the |
| | product to the fabric, which is a significant benefit |
| | for use. |

### Typical Mixture Composition Optimisation

In order to optimise the effectiveness, stability and usability of the solution, different acid concentrations and component chemicals were tested against each other.

For the sake of direct comparison, the solution mixtures were applied directly to the stained underarm/armpit areas of garments. The solution was then worked into the fabric then left to soak for a period of approx 30 minutes. The garments were subsequently subjected to a standard wash cycle at 40 deg C. Following the wash cycle, the stained areas were inspected and results photographically recorded. A summary of the tests is shown in the table below:

| Test | Results |
|---|---|
| Two preferred alcohol | The effectiveness of these two alcohol ethoxylates |
| ethoxylates were tested | is comparable. However, the Surfac ™ GM590 is |
| against each other - | preferred due to it's superior physical properties: |
| Surfac ™ GM590 vs | higher cloud point in solution and lower melting |
| Synperonic ™ A7 (both were | point resulting in better solution stability at lower |
| blended at 5 vol % with | temperatures and ease of blending. |
| 2 vol % Arlypon ™ VPC and | Refer to attached sheet: Comparative Test 1. |
| 93 vol % 1M HCl). | |
| Two preferred levels of HCL | The result was conclusive. In the majority of cases, |
| concentration were tested | the 2M solution was 100% effective in a single |
| against each other - 2M HCl | treatment cycle. Where as the 1M solution |
| vs 1M HCl (both were | sometimes required 2 treatments to achieve the |
| blended at 93 vol % with | same level of effectiveness. |
| 2 vol % Arlypon ™ VPC and | Refer to attached sheet: Comparative Test 2. |
| 5 vol % Surfac ™ GM590). | |
| Two preferred acid tolerant | The effectiveness of these two thickeners is |
| thickening agents were | comparable. However, the Arlypon ™ VPC is |
| tested against each other - | preferred due to it not discolouring the mixture as |
| Tomah3 ™ vs Arlypon ™ | much as the Tomah3 ™ |
| VPC (both were blended at | Refer to attached sheet: Comparative Test 3. |
| 2 vol % with 5 vol % Surfac ™ | |
| GM590 and 93 vol % 2M HCl). | |
| A preferred composition | The result was conclusive. The composition was |
| (93 vol % 2M HCl with 5 vol % | 100% effective after 2 treatment cycles. Where as |
| Surfac ™ GM590 and 2 vol % | the Laundress solution did not have any |
| Arlypon ™ VPC) was tested | appreciable effect on the stains. |
| against the only other | Refer to attached sheet: Comparative Test 4. |
| product on the market claiming | |
| to be able to remove armpit stains - | |
| The Laundress ™ Classic stain | |
| remover. | |

### CONCLUSIONS

Thus embodiments of the invention may be used as a laundry cleaning wash or pre-wash stain removal treatment for the cleaning of deodorant, antiperspirant and sweat residues and stains from fabrics and garments.

Whilst not being limited by theory, the presence of the acid in the cleaning agent solution acts to dissolve the water insoluble deposits, such as aluminium salts present in the residue build-up on the fabric of the garment, allowing the cleaning agent component to more effectively work at the removal and dispersion of the stain from the fabric.

Further it is considered that the Arlypon VPC thickening agent does not have any effect on the cleaning performance but is purely an addition to enhance the appearance and aid user application.

For embodiments in a liquid form, the composition should be fluid enough to be able to effectively penetrate the thicker multiple fabric layers, such as those found at the garment seams and be easily washed out of the fabric. However, the mixture should also have sufficient viscosity, so that the composition is sufficiently easy for the user to apply and control the amount and area of application, allowing more cost efficient use of the product to only the areas requiring cleaning.

Thus embodiments of the invention provide a chemical treatment for the removal of deodorant and antiperspirant stains from the armpit areas of a garment.

Hitherto, shirts which were unsightly due to underarm stains were often discarded as no commercially available stain remover was found to be effective at removing such stains. However embodiments of the invention benefit in that the stains may be removed and the shirts used without the unsightly stains.

Improvements and modifications may be made without departing from the scope of the invention. For example perfumes and/or dyes may be added to the composition to enhance the aesthetics of the composition.

1.-26. (canceled)

27. A composition when used as a stain remover on an armpit region of clothing materials, the composition comprising a cleaning agent and an acid.

28. A composition as claimed in claim 27, wherein the cleaning agent comprises a soap and/or a detergent, and wherein the cleaning agent is an aqueous based cleaning agent.

29. A composition as claimed in claim 27, wherein the cleaning agent comprises an alcohol ethoxylate, and wherein the cleaning agent comprises Synperonic' A7.

30. A composition as claimed in claim 27, wherein the acid comprises at least one selected from the group consisting of hydrochloric acid, citric acid, formic acid, nitric acid, sulphuric acid, acetic acid and phosphoric acid.

31. A composition as claimed in claim 27, comprising a strong acid, selected from:
hydrochloric acid;
hydrochloric acid and phosphoric acid; and
alcohol ethoxylate and hydrochloric acid.

32. A composition as claimed in claim 27, comprising 1-20 vol % cleaning agent, 5-15 vol % cleaning agent, or 8-12 vol % cleaning agent.

33. A composition as claimed in claim 27, comprising 70-99 vol % aqueous acid, or 85-95 vol % aqueous acid.

34. A composition as claimed in claim 27, wherein the acid has a molarity of 0.1-5M, molarity of 0.5-3M or 0.5-1.5M.

35. A composition as claimed in claim 27, comprising a gelling or thickening agent, wherein the gelling or thickening agent comprises an ethoxylated fatty amine.

36. A composition as claimed in claim 35, comprising 1-5 vol % of the gelling or thickening agent.

37. A composition as claimed in claim 27, when used on shirts.

38. A composition as claimed in claim 37, when used on cotton shirts.

39. A composition as claimed in claim 27, when used to remove stains caused by deodorant, antiperspirant, sweat or their mixtures, derivatives or products.

40. A method of removing stains from clothing, the method compromising contacting an armpit region of clothing materials comprising the stains with a composition according to claim 27.

41. A method as claimed in claim 40, comprising removing stains caused by deodorant, antiperspirant, sweat or their mixtures, derivatives or products, and wherein the composition is applied to the clothing material and the clothing material is then subjected to a subsequent washing step.
